(19) United States
(12) Patent Application Publication
(10) Pub. No.: US 2012/0078144 A1
(43) Pub. Date: Mar. 29, 2012

(54) BEDSORE PREVENTION SYSTEM, DEVICE & METHODS

(76) Inventor: Brian P. Sinykin, Plymouth, MN (US)

(21) Appl. No.: 13/236,468

(22) Filed: Sep. 19, 2011

Related U.S. Application Data
(60) Provisional application No. 61/383,850, filed on Sep. 17, 2010.

(51) Int. Cl. A61H 9/00

(52) U.S. Cl. 601/148; 128/889

(57) ABSTRACT

The present invention is directed to systems, devices and methods for preventing and treating bedsores. In particular, the invention is directed to the use of feedback mechanisms and application of dedicated protocols to identify and monitor therapeutic efforts, including the use of movement sensors, adjustable beds, adjustable wheel chairs, and a networking interface to deliver comprehensive, interactive therapies for the prevention and treatment of bedsores.

The present application claims priority to Provisional Application No. 61/383,850, filed Sep. 17, 2010, and incorporated herein in its entirety.

### FIELD OF THE INVENTION

The present invention is directed to systems, devices and methods for preventing and treating bedsores. In particular, the invention is directed to the use of feedback mechanisms and application of dedicated protocols to identify and monitor therapeutic efforts, including the use of movement sensors, adjustable beds, adjustable wheel chairs, and a networking interface to deliver comprehensive, interactive therapies for the prevention and treatment of bedsores.

### BACKGROUND OF THE INVENTION

Bedsores, also known as pressure ulcers, are a common, painful, debilitating and potentially deadly condition experienced by millions of individuals each year. Current estimates are that 1.3 to 3 million adults have pressure ulcers in the United States, and that more than 65,000 die from related complications each year. The estimated incidence of pressure ulcers is from 2.2% to 23.9% in long term care and 0% to 17% in home care. In elderly populations and in those who are institutionalized, pressure ulcers are one of the most costly diseases to treat. The cost of treatment can be in the range of $2,000 to $40,000 per pressure ulcer. Taking into consideration all direct, indirect and peripheral costs, over $25 billion total is spent annually on wound care in the United States. Each year the United States government spends an average of $3 billion on wound treatment and care for pressure sores and bedsores, and insurance companies pay out millions annually for this same treatment. Inflationary effects on these costs alone will push the amounts spent annually even higher.

With the advent of tens of millions of baby-boomers about to enter the early stages of the disease process, we are faced with overwhelming numbers of elderly people due to be housed in long term facilities that need to be tended to by caregivers from a smaller subsequent generation. This creates a supply/demand conflict that will significantly increase the cost of per patient care.

Pressure ulcers add an estimated burden of over $1 billion of expenditures and an additional 2.2 million Medicare hospital days to the United States health care system. Pressure ulcers can increase nursing time up to 50% and are very costly in time and resources. Total cost of manpower, resources and time invested in treatment continues to rise dramatically. The greatest cost of treating pressure ulcers in long term care is borne by the facility because hospital stays have shortened due to pressure from insurance companies to cut costs, placing higher numbers of high-risk patients into nursing homes sooner. Pressure ulcers represent one of the top four most common deficiencies found in long term care facilities.

Therefore, a need exists for improved systems, methods, and devices for prevention of bedsores.

### SUMMARY OF THE INVENTION

The present invention is directed to systems and methods for monitoring and treating of pressure ulcers. More specifically, the invention is directed to systems and methods for utilizing a plurality of patient treatment protocols, in conjunction with information from a plurality of devices—both monitors and treatment related—to generate appropriate protocols for primary care staff, while simultaneously allowing for monitoring of that information and therapeutic care by medical staff.

The system and methods allow for reports to be generated based upon the protocols that are to be administered. Such reports can include listings of the protocols, their efficacy, and recommendations for changes in protocols. These reports can be used by, for example, primary care staff, physicians, and administrators. In some implementations hospitals and/or residential care providers will utilize the reports. The reports can also be used by the system to generate additional protocols and test procedures, the test procedures to determine whether the protocols are working properly. Other service providers can also optionally use the reports, such as for Medicare billing, for health or insurance evaluation or processing, for attorneys reviewing the nature of the provided care, etc.

In certain implementations the invention includes specific devices, such as treatment equipment, configured and arranged to specifically work with the treatment protocols. A first example of such equipment includes a specialized bed or beds for treatment of patients with pressure ulcers. The bed includes a soft pad that measures how long a patient stays in one position so it can send a signal to the caretakers when to move the patient and if that is not done in a reasonable time period automatically turn them. It also provides additional directions on other protocols called out in the pressure ulcer protocols. It also will gather data needed for physicians and organizations to meet both state and federal laws for pressure ulcers as well as information needed for the care of the patient.

Other specific devices include, for example, a wheel chair cushion that can add to the prevention of bedsores, and medical telecare products to allow the system to function outside of traditional hospital settings.

### DRAWINGS

The invention may be more completely understood in connection with the following drawings, in which:

FIG. 1 shows a general schematic diagram of a system made in accordance with an implementation of the invention.

FIG. 2 shows a diagram specific implementation of a system made in accordance with an implementation of the invention, showing participants and the flow of information between them.

FIG. 3A shows a simplified top plan view of a pressure ulcer monitoring mat made in accordance with an implementation of the invention.

FIG. 3B shows a simplified side perspective view of the pressure ulcer monitoring matt of FIG. 1, the mat placed on a bed.

FIG. 4A shows a top cross sectional view of an example embodiment of an ulcer monitoring mat made in accordance with an example implementation of the invention.

FIG. 4B shows a top cross sectional view of an example embodiment of an ulcer monitoring mat made in accordance with an example implementation of the invention.

FIG. 5A shows a simplified top view of a person sleeping atop a pressure ulcer monitoring mat, the person in a first sleeping position.

FIG. 5B shows a simplified top view of a person sleeping atop a pressure ulcer monitoring mat, the person in a second sleeping position.

FIG. 6 shows a schematic diagram of components of a pressure ulcer prevention system made in accordance with an implementation of the invention.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

Bedsores are easier to prevent than to treat, but that doesn't mean the process is easy or uncomplicated. Although wounds can develop in spite of the most scrupulous care, it's possible to prevent them in many cases.

The present invention is directed to systems and methods for monitoring and treating of pressure ulcers. More specifically, the invention is directed to systems and methods for utilizing a plurality of patient treatment protocols, in conjunction with information from a plurality of devices—both monitors and treatment related—to generate appropriate protocols for primary care staff, while simultaneously allowing for monitoring of that information and therapeutic care by medical staff.

The system and methods allow for reports to be generated based upon the protocols that are to be administered. Such reports can include listings of the protocols, their efficacy, and recommendations for changes in protocols. These reports can be used by, for example primary care staff, physicians, and administrators. In some implementations hospitals and/or residential care providers will utilize the reports. The reports can also be used by the system to generate additional protocols and test procedures, the test procedures to determine whether the protocols are working properly. Other service providers can also optionally use the reports, such as for Medicare billing, for life insurance evaluation or processing, for attorneys reviewing the nature of the provided care, etc.

In certain implementations the invention includes specific devices, such as treatment equipment, configured and arranged to specifically work with the treatment protocols. A first example of such equipment includes a specialized bed or beds for treatment of patients with pressure ulcers. The bed include is a soft pad that measures how long a patient stays in one position in either a bed or wheelchair so it can send a signal to the caretakers when to move the patient and if that is not done in a reasonable time period automatically turn them. It also provides additional directions on other protocols called out in the pressure ulcer protocols. It also will gather data needed for physicians and organizations to meet both state and federal laws for pressure ulcers as well as information needed for the care of the patient.

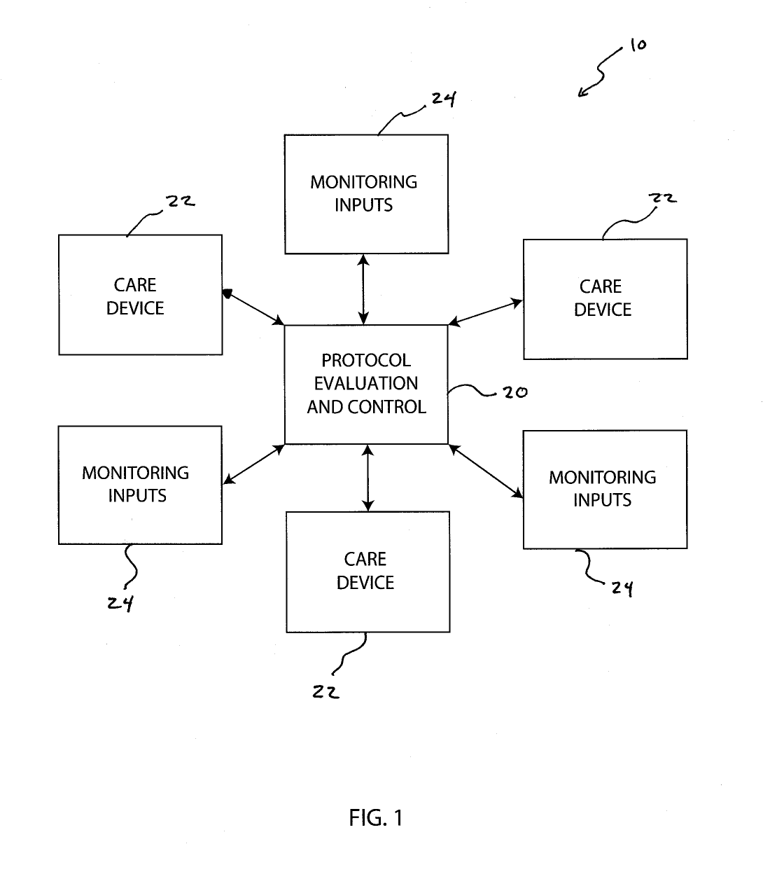

In reference now to the drawings, FIG. 1 shows a schematic diagram of an overview of a system 10 created in accordance with an implementation of the invention. The system 10 includes a protocol evaluation and control system 20 configured to evaluate patient health data, to propose refinements to care protocols, and then to monitor the effect of those refinements. The protocol evaluation and control system 20 interfaces with multiple care devices 22 (such as beds and wheelchairs) as well as multiple monitoring inputs 22 (such as blood pressure monitors, movement monitors, etc.). The monitoring inputs 22 can also include, for example, feedback provided by care givers (such as a subjective evaluation of progression of healing or deterioration of pressure ulcers) or test results that are automatically or manually entered (such as a blood test for bacterial infection). The monitoring inputs 22 can further include information about medication that has been prescribed, or other health care treatments that are currently under way.

The protocol evaluation and control system 20 receives the monitoring inputs and optionally information from care devices and then provides revisions to the protocols, and then informs the care device or care provider of changes to be made in the patient's treatment. For example, if a monitoring input indicates that a patient has pressure ulcers on the left side of their hips, then a recommendation may be to rotate the patient hourly so that they are not continuously sleeping on their left side. The recommendation may be to make sure the patient spends at least 75 percent of their time on their right side or back (for example).

Such a protocol (for spending at least 75 percent of their time on their right side or back can then be monitored using a care device, such as a bed that has a plurality of sensors to determine where and how the patient is sleeping, as well as how much they are moving. In addition, the protocol evaluation and control system 20 can optionally provide similar information in the form of a report that is received by care givers who can then proceed to further monitor performance.

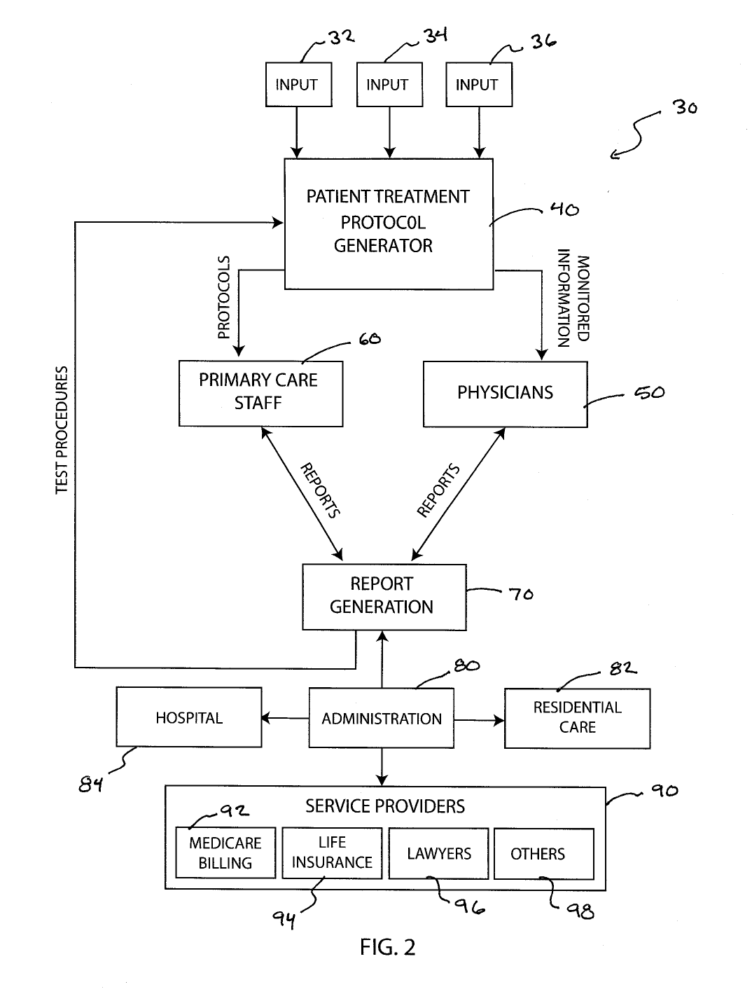

FIG. 2 shows a diagram specific implementation of a system 30 made in accordance with an implementation of the invention, showing participants and the flow of information between them. The system 30 is shown as an example implementation of the present invention, but it will be understood that alternative implementations are possible that will deviate from this depicted system 30. In the system 30, a series of patient treatment protocols (typically hosted on a networked server, for example) are generated at the patient treatment protocol generator 40. These patient treatment protocols are used to define a treatment protocol for a patient. The protocols can include, for example, how and when a patient should be turned, how much movement the patient should engage in, etc. The protocols are determined, in part, but the inputs 32, 34, 36 (for example), which can include monitoring inputs as well as care device inputs

The protocols can be provided to primary care staff 60, such as nurses or nursing home attendants, or to physicians. In some cases the physician receives monitored information, such as how the patient's health is changing, while the protocols are provided to other staff (such as nurses) who will undertake the implementation thereof. It will also be understood that in some implementations this information can go to both groups of people, or the information can be otherwise sent to various persons. This information, including protocols and monitored information, can be generated at report generation sub-system 70. These reports can include efficacy treatment, type of treatment, expenses, etc. This information can be further transmitted to various administration bodies 80, and used to interface with residential care administrators 82 or hospital administrators 84. Various service providers 90 can also be informed, including (for example) medicare billing service providers 92, life insurance service providers 94, lawyers 96, and others 98. A feedback mechanism providing test procedures from the report generation sub-system 70 can be provided to further modify the patient treatment protocols.

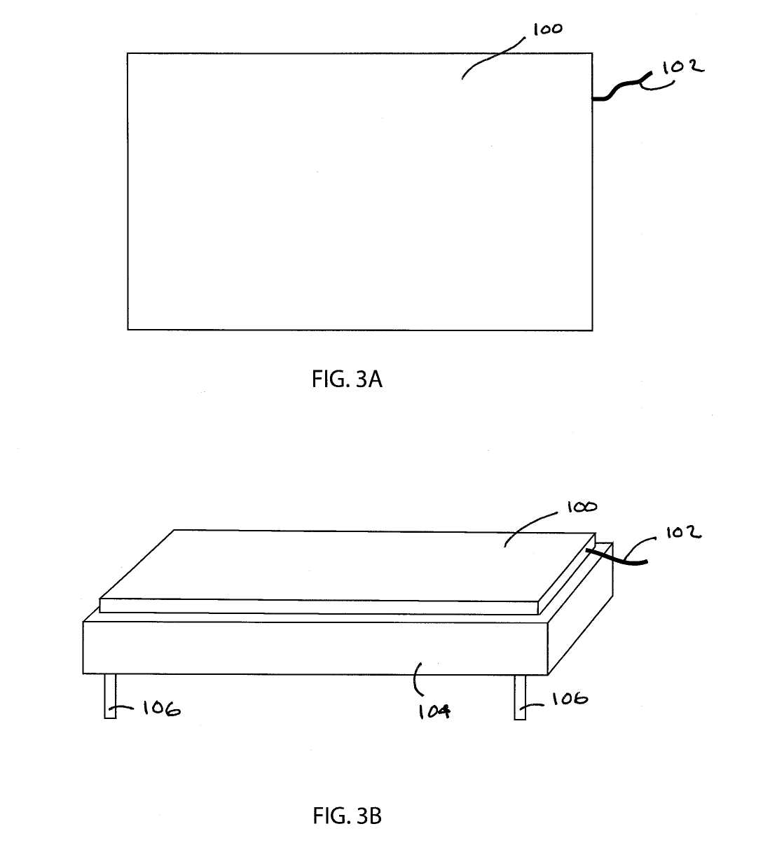

FIG. 3A shows a simplified top plan view of a pressure ulcer monitoring mat 100 made in accordance with an implementation of the invention. The mat 100 includes a monitoring cable 102 configured to provide information back to a patient treat protocol generator (such as shown in FIG. 2). In response, the protocol generator can request different or additional treatment protocols.

FIG. 3B shows a simplified side perspective view of the pressure ulcer monitoring mat 100 of FIG. 1, the mat placed on a bed. The mat 100 includes the connector cable 102 for transmitting data to a monitoring location. The bed 104 is shown with legs 106.

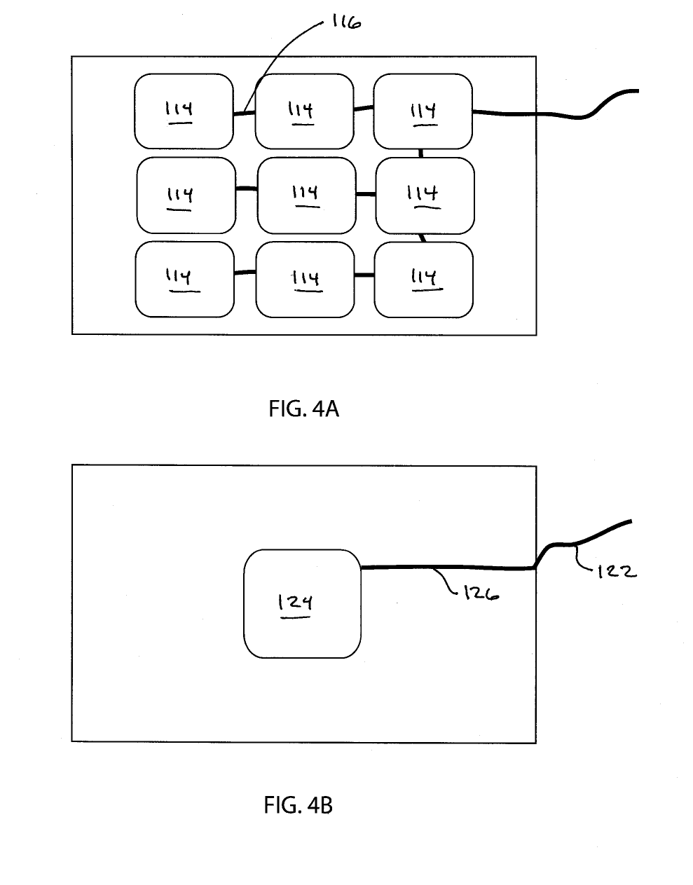

FIG. 4A shows a top cross sectional view of an example embodiment of an ulcer monitoring mat 110 made in accordance with an example implementation of the invention. The ulcer monitoring matt 110 includes nine independent sensor pads 114, connected by cabling 116. This system allows a multitude of positions to be monitored because each sensor pad 114 can independently report whether the pad is being contacted by a patient.

FIG. 4B shows a top cross sectional view of an example embodiment of an ulcer monitoring mat 120 made in accordance with an example implementation of the invention. The mat 122 includes a single sensor pad 124 covering a portion of the bed, along with a communication cable 126.

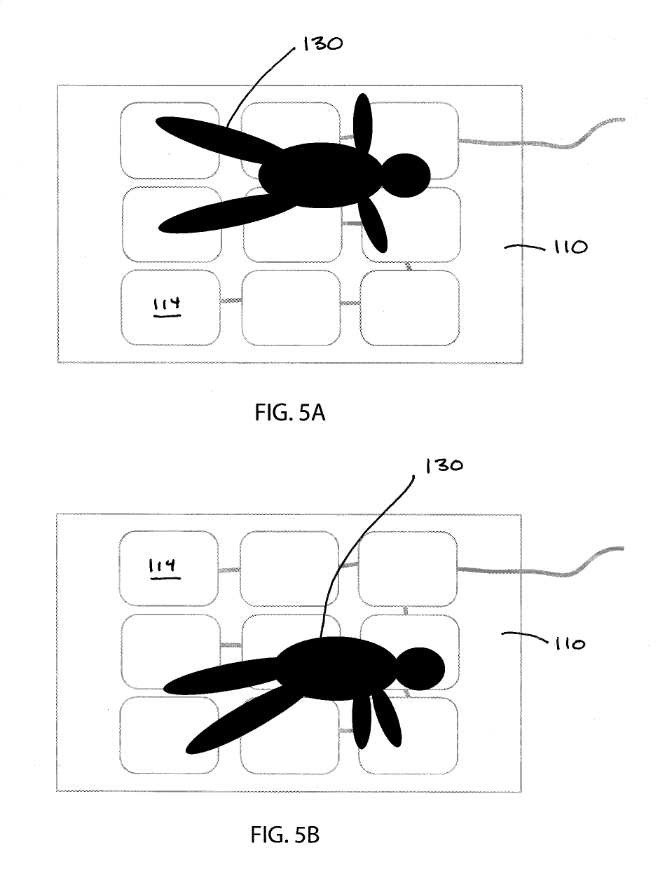

FIG. 5A shows a simplified top view of a person 130 sleeping atop a pressure ulcer monitoring mat 110, the mat containing a plurality of sensor pads 114 (as shown in FIG. 4A), the person in a first sleeping position. It will be observed that the person 130 is touching the top six sensor pads 114. FIG. 5B shows the same monitoring matt 110 with a person sleeping atop it, but the person is in a second sleeping position. In this embodiment the movement of the patient would be indicated by the different contacts with the sensor pads 114.

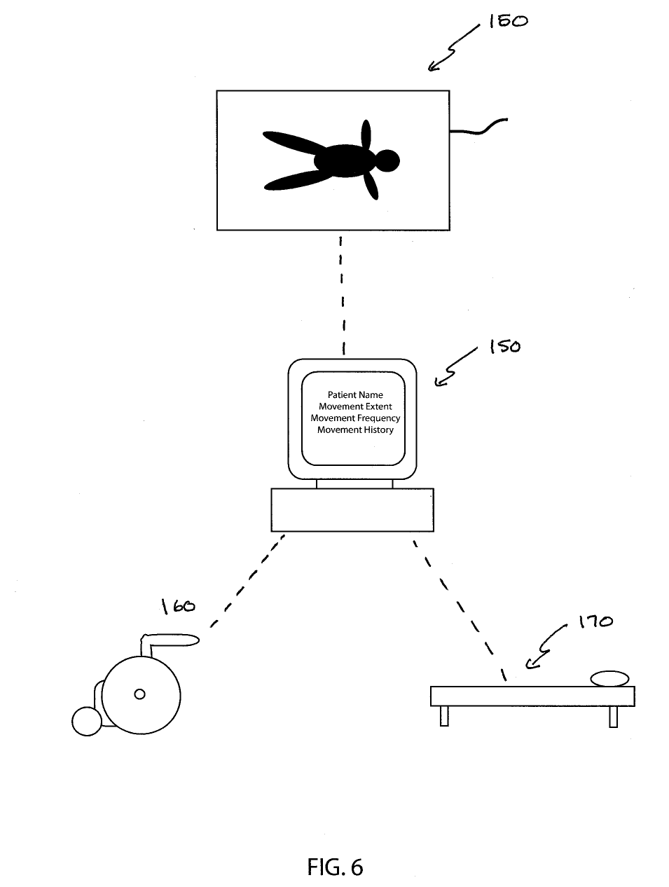

FIG. 6 shows a schematic diagram of components of a pressure ulcer prevention system made in accordance with an implementation of the invention. A monitor 150 shows patient information (generalized, for example, as patient name, movement extent, movement frequency, and movement history), and communication linkages with a sleeping mat 150, wheelchair 160, and bed 170. The system of the present invention can provide protocols that integrate information from the sleeping mat, wheelchair, and bed to make sure that treatment and monitoring is harmonized between the devices and various data inputs.

In some implementations the invention includes various mattresses provide pressure relief, spine alignment, and temperature control. In some implementations the bed has nine individual air cylinders on each side of the bed, and a system of air intake and release valves, the mattress conforms precisely to unique weight and shape to support the parts of a body that rests on it. And when a patient moves during the night, the cylinders automatically self-adjust, taking in and releasing just enough air to provide the correct support for your new sleep position.

A further example apparatus for use with the present invention is a wheelchair cushion system with a dynamic cushion system. The dynamic cushion system can use an automatic pressure relieving device that ensures adequate pressure relief and blood flow. Alternate cells of the cushion are automatically inflated and deflated to the desired firmness on an adjustable timed cycle. This action changes pressure contact points and stimulates circulation to the compressed tissue. Circulation is maintained to all areas of the posterior so the primary cause of skin breakdown is eliminated.

The cushion can be made of soft but durable Neoprene (no latex) and has a series of air cells. The cells are shaped to fit the contours of the body for comfort and support. They are also reinforced with internal air bladders to ensure long service life. The two ischial air cells are attached to the cushion base with Velcro enabling them to be easily repositioned if needed. Alternating air cells are capable of being inflated and deflated at different pressure levels and for varying times for maximum pressure relief where and when you want.

Typically the wheelchair cushion system is custom made, and can be built to whatever size works best for the client's needs. In other words, no standard sizes, but rather the correct size. Generally the cushion can support weights in excess of 400 pounds and bariatric sizes can be made.

If a patient has a current pressure sore, we may customize the cushion with a convertible cell so there will be virtually zero upward pressure directly under the sore until complete healing is achieved. Once the sore is healed, the cell is integrated back into normal operation in just seconds.

### Prevention and Treatment Protocols

Various protocols may be used by the system for determining appropriate care by a patient's care staff (as well as to select appropriate equipment for monitoring and treating the patient. As noted above, a pressure ulcer is any lesion caused by unrelieved pressure that results in damage to the underlying tissue. Although friction, shear and moisture are not primary causes of pressure ulcers, friction, shear and moisture are important contributing factors to the development of pressure ulcers. Pressure ulcers are generally found over bony prominences. Pressure ulcers are staged according to their extent of tissue damage. The current definitions for the stages of pressure ulcers are as follows:

Stage I: An observable, pressure-related alteration of intact skin, whose indicators as compared to an adjacent or opposite area of the body may include changes in one or more of the following parameters: skin temperature (warmth or coolness), tissue consistency (firm or boggy), sensation (pain or itching) and/or a defined area of persistent redness in lightly pigmented skin, whereas in darker skin tones, the ulcer may appear with persistent red, blue or purple hues.

Stage II: Partial thickness skin loss involving epidermis, dermis or both. The ulcer is superficial and presents clinically as an abrasion, blister or shallow crater.

Stage III: Full thickness skin loss involving damage to, or necrosis of, subcutaneous tissue that may extend down to, but not through, underlying fascia. The ulcer presents clinically as a deep crater with or without undermining of adjacent tissue.

Stage IV: Full thickness skin loss with extensive destruction, tissue necrosis, or damage to muscle, bone, or supporting structures (e.g., tendon, joint capsule). Undermining and sinus tracts also may be associated with Stage IV pressure ulcers.

Specific protocols provided by the physician or care giver can include:

Ensure proper diagnosis and prognosis of the wound. Many lower extremity wounds are caused from arterial insufficiency; venous insufficiency and/or peripheral neuropathy are inappropriately diagnosed as pressure ulcers.

Become familiar with the facility's policies, procedures and protocols for pressure ulcer prevention and treatment.

Become familiar with current standards of practice for pressure ulcer prevention and treatment.

Take an active role in assessing and developing a regimen relevant to preventing or treating a wound and responding appropriately to any notice of changes in condition (the facility must notify the Physician/Practitioner when a wound develops, declines or fails to heal)

Generally at least the following protocols should be undertaken:

### Prevention Interventions

Prevention interventions include, for example:

Daily monitoring of the skin with a weekly skin inspection by licensed staff.

A comprehensive risk assessment upon admission, weekly for the first four weeks after admission, with each change of condition and quarterly

Provide appropriate pressure reduction in the bed & sitting surface. Static surfaces are non-powered, usually foam and should replace the entire mattress (egg-crates are not considered pressure reduction surfaces). Static surfaces should be used for prevention and non-complicated stage I ulcers. Dynamic surfaces are powered surfaces and there are two types, low-airloss and air-fluidized. Low-airloss surfaces have air chambers. They are appropriate for stage II ulcers and non-complicated stage II-IV. Air-Fluidized beds have air blown through ceramic beads creating a fluidized motion. These are for flaps or grafts and complex stage III or IV wounds not healing on a low-airloss surface. Generally, it is not appropriate to use a donut or ring type devices.

Institute an individualized turning and repositioning schedule

Pad and protect bony prominences (note: sheepskin, heel and elbow protectors provide comfort and reduce shear and friction, but do NOT provide pressure reduction).

Do NOT massage over bony prominences.

Float heels (on pillows or devices that support the entire calf, but float the heals).

Keep skin clean and dry.

Peri-care after each incontinence episode, including the application of a skin barrier

Bowel and Bladder program when appropriate.

Foley catheter and/or fecal tubes/pouches as appropriate.

Use corn starch to wick up moisture (no powders).

Bathe with mild soap, rinse and gently dry.

Moisturize dry skin.

Provide adequate nutrition and hydration.

Provide adequate pain relief.

Monitor and manage diabetes.

Provide appropriate referrals for psychosocial needs and/or to a podiatrist and/or a wound consultant.

### Treatment Interventions

The treatment of a pressure ulcer should include those interventions already listed as well as the following topical treatment interventions:

Provide a MOIST environment for wound healing.

Cleanse wounds initially and at each dressing change.

Normal saline is the preferred cleansing agent.

Use safe and effective irrigation pressures from 4-15 psi.

Wounds with adherent materials may benefit from non-cytotoxic commercial cleansers

Utilize skin preps/sealants to protect the surrounding skin

Eliminate wound dead space by LOOSELY filling all cavities

Do NOT use topical antiseptics: Dakins solution, povidone iodine, iodophor, hydrogen peroxide and acetic acid. Instead to decrease the bacterial load of a wound use products containing silver (it is not cytotoxic to the wound bed).

Remove all devitalized tissue from the wound bed. However, stable heel ulcers with protective eschar with NO S/S of infection should NOT be debrided.

Use an appropriate safe form of debridement. Autolytic is safe and selective and is done by providing a moist environment to the wound bed. If autolytic is too slow then the use of an enzymatic debriding agent maybe necessary. If there is S/S of infection immediate use of sharp or surgical debridement by the Physician or Practitioner may be necessary. The use of mechanical debridement (wet-to-dry, whirlpools, etc) should only be used when no granulation tissue is present as it is non-selective and can be painful and lead to bleeding (note a wet-to-dry dressing should be ordered for debridement ONLY).

If the wound edges are rolled under debridement with a silver nitrate stick by the Physician or Practitioner maybe necessary to stimulate healing. Also, callused wound edges must be debrided.

Treatment with topical antibiotics when localized S/S of infection. Do not use topical antibiotics for prevention. If the resident has S/S of systemic infection (sepsis, cellulitis, osteomyelitis, bacteremia, etc.) then systemic antibiotics are necessary.

When a wound bed is dry the use of hydrogels, transparent films and/or hydrocolloids are appropriate (do not use hydrocolloids or transparent films on infected wounds).

When a wound bed is draining the use of foams and calcium alginates are appropriate

When ordering topical dressings use the category name (hydrogel, foam, etc.) instead of the name brand product.

Adjunctive therapy (e.g., E-Stim, the V.A.C, growth factors, skin equivalents, etc), should be utilized on chronic wounds that have not responded to conventional treatment.

While the present invention has been described with reference to several particular implementations, those skilled in the art will recognize that many changes may be made hereto without departing from the spirit and scope of the present invention.

1. A method for prevention and treatment of pressure ulcers; the method comprising:
providing two or more monitoring devices for assessment of pressure ulcer conditions in a person, wherein the two or more monitoring devices are configured for providing data relating to pressure ulcer properties;
providing at least one therapeutic device configured for treatment of pressure ulcers;
receiving information relating to pressure ulcer properties from at least one of the two or more monitoring devices;
automatically determining a treatment protocol based upon the information received and the therapeutic device which is available;
undertaking the performance of the treatment protocol utilizing the therapeutic device; and
generating a report as to the efficacy of the treatment protocol.

2. The method of claim 1, wherein the step of undertaking the performance of the treatment protocol utilizing the therapeutic device comprises changing the pressure in the cell of a bed.

3. The method of claim 1, wherein the step of undertaking the performance of the treatment protocol utilizing the therapeutic device comprises changing the pressure in the cell of a wheelchair.

4. The method of claim 1, further comprising selecting one or more new protocols based upon the efficacy of the first treatment protocol.

5. A system for prevention and treatment of pressure ulcers in a patient; the system comprising:
two or more monitoring devices for assessment of pressure ulcer conditions in a person, wherein the two or more monitoring devices are configured for providing data relating to pressure ulcer properties;
at least one therapeutic device configured for treatment of pressure ulcers; and
a computer;
wherein the monitoring devices are configured to communicate with the computer to provide patient-based information and to automatically determine a treatment protocol based upon the information received and based upon the therapeutic device which is available.
